(19) United States
(12) Patent Application Publication
(10) Pub. No.: US 2004/0199479 A1
(43) Pub. Date: Oct. 7, 2004

(54) Inventory control carton with two compartments and method for using same

(75) Inventors: James N. Elesh, Evanston, IL (US); Alan Sax, Chicago, IL (US)

Correspondence Address: Michael Best & Friedrich LLC, Suite 1900, 401 North Michigan Avenue, Chicago, IL, 60611, US

(73) Assignee: FLEXI-MAT CORPORATION, Chicago, IL

(21) Appl. No.: 10/798,854

(22) Filed: Mar. 11, 2004

Related U.S. Application Data
(62) Division of application No. 09/696,510, filed on Oct. 25, 2000, now abandoned.

(51) Int. Cl. G06F 17/00

(52) U.S. Cl. 705/500

(57) ABSTRACT

A unitary carton has two compartments. A first of the two compartments can be closed and sealed while the other compartment can be temporarily closed. This way a manufacturer can insert a product into the first compartment, then close and seal that compartment and ship the carton to a distributor. The distributor can open the temporarily closed compartment and add a second product selected by a customer. The carton is then shipped to the retailer or consumer with the two products in it. In the described example, the first product is a pillow, and the second product is a cover which can be combined with the pillow to form a pet bed. The pillow is placed in a plastic bag and a vacuum is drawn to reduce the size of the pillow so that it fits snuggly in its compartment. The pet bed packaged and assembled in this manner permits the distributor to substantially reduce its inventory space requirements.

This application is a division of prior, co-pending U.S. patent application Ser. No. 09/696,510, filed Oct. 25, 2000.

This invention relates to inventory control cartons and to means for and methods of supplying a customer's customized request from an inventory. In particular, the invention relates—but not exclusively—to cartons for pet beds with an associated cover.

The invention may find use in many different industries and under many different situations where sales include mix and match products—especially where it is most convenient for manufacturers to package a first product and a merchant to package a second product with the first to provide a combination of the first and second products in response to a customer's selection. For convenience of explanation, the following description is given in terms of pet beds for dogs and cats. However, the selection of pet beds is not to be taken as limiting the invention and its uses. Quite the contrary, there are many other examples that could have been selected.

A dog's bed is often a large pillow with an attractive cover on it. A cat's bed would be a smaller pillow, also with a cover on it. Depending upon the animal's weight and size, the pillows may have a variety of sizes and shapes. Likewise, the covers are variegated and may have any number of colors, fabric designs and a variety of sizes and shapes to match the corresponding pillow. In fact, many people will select a pet bed to coordinate with colors in a room.

In the past, a distributor would specify to a manufacturer a particular size or shape of pillow with a particular cover on it. The covered pillow would be boxed as a complete unit by the manufacturer and shipped to the distributor to be maintained in inventory until that combination of pillow and cover was ordered by the distributor's customer. This required the distributor to maintain a relatively large inventory of pet beds, due to the variety of covers and pillows. Thus, the cost of storing the various matched sets of covers and pillows in inventory is high.

It is preferable to inventory a relatively small number of pillows (which occupy a relatively large volume of space) and a great variety of covers (which occupy a relatively small volume of space) which may be mixed and matched responsive to a customer's request. This raises issues of who (as between the manufacturer and distributor) is to maintain inventories of pillows and covers, how the pillow and cover may be packaged, how the size of the resulting carton may be minimized, and how the carton filled with products may pass from the manufacturer to the final customer with a minimum amount of handling.

Accordingly, an object of the invention is to reduce the size of the pillow to a minimum and to put it in the reasonably smallest box possible. Here, an object is to facilitate such packaging while maintaining the mix and match possibility.

A further object is to enable the manufacturer to make, package, and ship the pillows, while enabling the distributor to add a cover selected by a customer with minimal handling of the manufacturer's original packaging.

In keeping with an aspect of the invention, these and other objects are accomplished by a two-compartment box having a relatively large compartment which may receive a pillow and then be sealed at the factory. To reduce the size of the pillow before insertion into the box, it is placed in a plastic bag. Then, a vacuum pump draws the air out of the plastic bag, thereby squeezing the pillow to a much smaller size. While so squeezed into this small size, it is placed in the large compartment of the box which is then sealed. The second compartment of the box may be very small to ultimately receive a folded cover which is selected from the distributor's inventory of covers. The small compartment is temporarily closed by the manufacturer, and later the distributor may insert a cover therein and then seal it after the customer makes his selection.

A preferred embodiment will be understood best from the following specification taken with the attached drawings, in which:

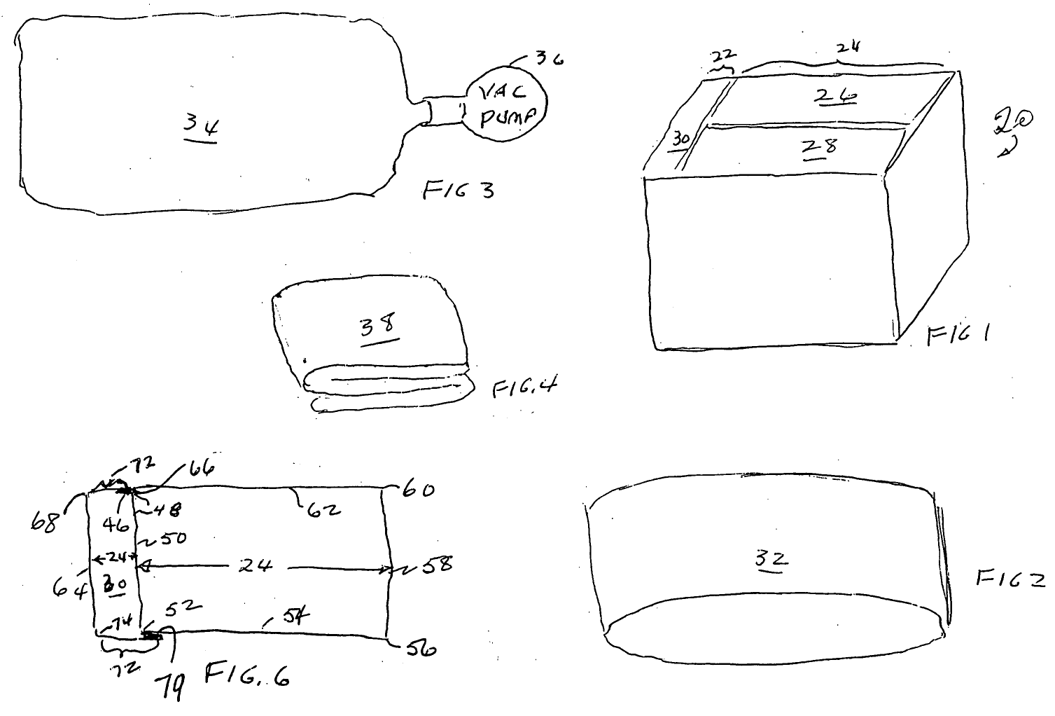

FIG. 1 is a perspective view of the inventive box or carton;

FIG. 2 is a perspective view of a pillow for a pet;

FIG. 3 is a plan view of a plastic bag for receiving the pillow of FIG. 2 and of a vacuum pump for evacuating the bag;

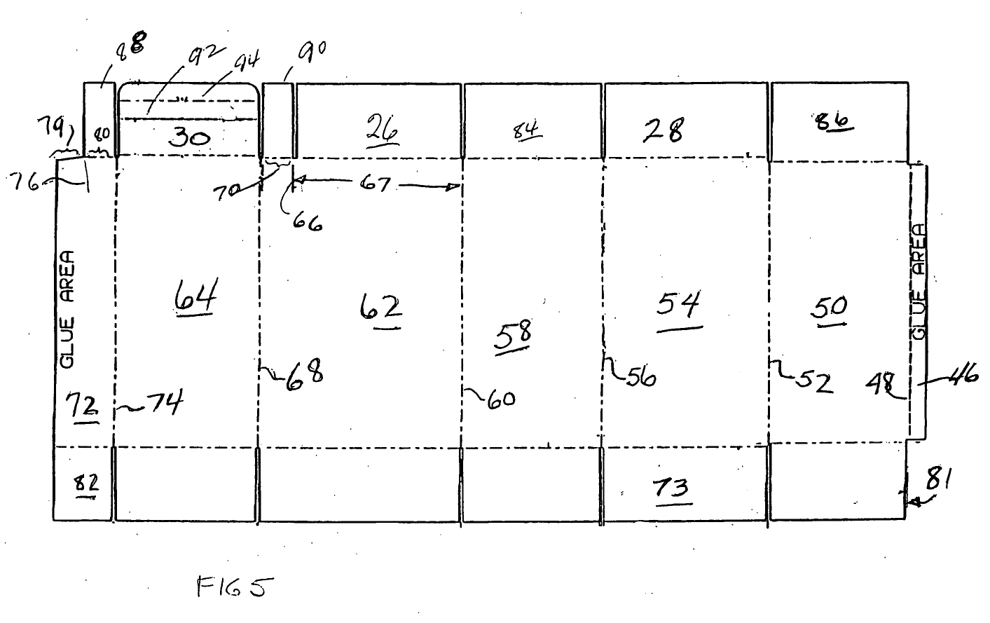

FIG. 4 is a perspective view of a folded cover for the pillow of FIG. 2;

FIG. 5 is a drawing of a blank for making the carton of FIG. 1; and

FIG. 6 is a top plan view of the blank of FIG. 5, folded to form a tube having a rectangular cross section which becomes the box or carton of FIG. 1.

In greater detail, a box or carton 20 (FIG. 1) has two compartments 22 and 24. At the time when the manufacturer ships the carton, flaps 26, 28 are sealed to close the larger compartment 24. The flap 30 is tucked into the box so that the smaller compartment 22 is temporarily closed, but not sealed.

Large compartment 24 is dimensioned to hold a pillow or stuffing for the pet's bed. The small compartment 22 is designed to hold the cover for the pillow. According to the invention herein, the manufacturer ships carton 20 with the pillow in place and compartment 24 sealed. The small compartment 22 is normally empty when carton 20 is shipped. The distributor inserts a cover of the customer's choice into small compartment 22 and, optionally, seals flap 30. Then, the carton is delivered to the customer.

FIG. 2 shows a pillow 32 which may be used as a dog's bed, for example. The pillow 32 is initially larger than and cannot easily fit within the large compartment 24 in carton 20. The inventive method involves shrinking the pillow volume so that the pillow fits into large compartment 24 quickly and easily.

FIG. 3 shows a plastic bag 34 which is large enough to easily receive the pillow 32, even when fluffed. After the pillow 32 is positioned inside the bag 34, a vacuum pump 36 is connected to the bag in order to suck air from the bag, thereby compressing the pillow 32. After the pillow is sufficiently compressed, the bagged pillow snuggly fits into the large compartment 24. The manufacturer now seals the flaps 26, 28 and ships the box to a distributor, with the pillow in the large compartment. The distributor typically maintains a small inventory of boxed pillows of various shapes and sizes and a large inventory of folded covers of corresponding shapes and sizes and various colors and fabric patterns.

When a customer orders a pet bed, he selects a particular pillow and cover 38 (FIG. 4). The distributor opens the small top flap 30 and inserts the selected cover 38 into the small compartment and under flap 30 which is then closed and preferably sealed. The compartment containing the pillow is not disturbed. The carton is then delivered to the customer.

The carton is made from the corrugated cardboard blank 40 shown in FIG. 5. Solid lines show where the blank is cut and dashed lines show where the blank is folded. As can be seen from an inspection of FIG. 5, the blank has a series of five panels with a glue flap on each end.

To form the blank into a box, an inside glue flap 46 is folded upwardly along line 48 to approximately 90°, with respect to a divider panel 50. Then, panel 50 is folded along line 52 to about 90° with respect to front panel 54. The folding continues along line 56 as side panel 58 is folded along line 60, again to about 90° with respect to back panel 62. Thus, a first series of three panels in the blank have been folded at right angles with respect to each other in order to form three sides of a first and large compartment 24 of box 20.

At this point, the blank has been folded into a tube having a rectangular cross-section (FIG. 6). While the dimensions will change with various types of boxes, typical dimensions for a pet bed box are described herein in order to better explain the next step in the box assembly operation. The divider panel 50 and the two side panels 58 and 64 are nearly the same width, approximately 1/8″ for each fold. In this example, the panel widths 50, 58, 64 are 12, 12½, and 12¼ inches wide, respectively. However, the fourth panel in the series, back panel 62, is 17½ inches wide; or, stated otherwise, it is as wide as the sum of the sides of both compartments 22 and 24. This extra width of approximately 5 inches over the panel widths of the first three panels provides enough cardboard for one part 70 of the panel 62 to form one side wall of the small compartment 22.

In order to secure the rectangular tube in its folded condition, the inside glue flap 46 is glued to the inside surface of the back panel 62 along line 66 which separates the widths of the two compartments 22 and 24, thereby completing the large compartment 24. The remaining width 67 of back panel 62 extending from location 66 where inside glue flap 46 is glued to the edge 60 of panel 58, is approximately equal to the width of front panel 54 with a little relief to facilitate the folding of the cardboard.

The left side panel 64 provides an outside wall for the carton, including both of the two compartments, and also is the wide wall of small compartment 22. Panel 64 is folded along line 68 which leaves the space 70 between the glue line 66 and fold line 68 in order to form one side of the small compartment 22. Next, the outside glue flap 72 is folded along line 74. A margin 79, which has a length of about half the length of the flap 72, is then glued to the edge of front panel 54 (see FIG. 6). The remainder 80 of glue flap 72 forms a side of the small compartment opposite the panel part 70.

To complete the box, the bottom forming flaps 81 are folded in a conventional manner toward the center of the box and glued in place. A tab 82 on the bottom of glue flap 72 is glued to bottom flap 73. The bag containing the pillow is placed in the large compartment 24 and flaps 84, 86 are folded over the pillow and toward the center of the box. Then, the flaps 26, 28 are folded over flaps 84, 86 and glued in place.

Two side flaps 88, 90 are folded over small compartment 22. The top flap 30 is folded along lines 92, 94 and tucked over side flaps 88, 90 and into the empty small compartment. The box is now ready to be shipped to the distributor.

When the time comes to place a cover in the box, the top flap 30 is pulled out, the selected cover is placed in the small compartment and the flap is again tucked into the small container.

The carton is now ready to be shipped to the retailer or consumer.

By using a box of this construction, distributors of products having two components can substantially reduce their inventory space requirements, and manufacturers can ship a first component in a sealed first compartment of the box, and the distributor can select a corresponding second component from its own inventory and insert that second component into a second compartment of the same box upon a customer's order. The distributor need not inventory, for example, three units of five different size pillows in each of four different color covers, i.e. 60 complete pet beds. Instead, the distributor may be comfortable maintaining an inventory of only 15 pillows and 60 folded covers, because the five different size pillows can be matched with the selected size and color cover on site at the distributor's warehouse.

Those who are skilled in the art will readily perceive various modifications that fall within the scope and spirit of the invention. Therefore, the appended claims are to be construed to cover all equivalent structures.

The claimed invention is:

1. A method of supplying a product from a first party to a second party comprising:
the first party providing a first portion of the product;
the first party providing a second portion of the product, the second portion having one of a plurality of decorative qualities, the second portion formed to be applied to the first portion;
the first party supplying a plurality of the second portions of the product to a distributor, the plurality of second portions including more than one of the plurality of decorative qualities;
the first party shipping a first portion to the distributor after supplying a plurality of the second portions of the product to the distributor; and
the distributor selecting one of the plurality of decorative second portions and packaging it in a box along with the first portion shipped from the manufacturer and supplying the boxed first and second portions to the second party.

2. The method of claim 16, wherein the first portion is shipped from the first party in one compartment of a two-compartment box, the distributor inserting the selected one of the plurality of decorative second portions into a second compartment of the two-compartment box.

3. The method of claim 17, wherein the first portion is a pillow and the second portion is a pillow cover.

4. The method of claim 16, wherein the first portion is a pillow and the second portion is a pillow cover.

5. A method of supplying a product from a manufacturer to a customer comprising:
supplying a first number of first portions of the product from a manufacturer to a distributor, the first portion being contained in a first compartment of a two-compartment box;
supplying a second number of second portions of the product from the manufacturer to the distributor, the second number being substantially greater than the first number, the second portions having a decorative quality and being formed to be applied to the first portions;
the distributor receiving from a customer an order for the product;
the distributor selecting one of the second number of second portions based on the customer order;
the distributor placing the selected second portion in a second compartment of the two-compartment box; and
the distributor supplying the boxed product to the customer.

6. The method of claim 20, wherein the first portion is a pillow and the second portion is a pillow cover.

7. The method of claim 21, wherein air is removed from the pillow prior to placing the pillow in the first compartment of the box.

8. A method of supplying a pet bed from a manufacturer to a customer comprising:
manufacturing a pillow of the pet bed;
placing the pillow in a first compartment of a two-compartment box;
shipping the box to a distributor;
supplying the distributor with a plurality of decorative covers for the pillow of the pet bed, the plurality of decorative covers being of various designs; and
receiving an order for a pet bed from a customer, the distributor selecting one of the plurality of decorative covers in response to the order and placing the selected decorative cover in a second compartment of the two-compartment box.

9. The method of claim 23, wherein air is removed from the pillow before placing it in the first compartment.

10. The method of claim 23 further comprising shipping the box to the customer.
